(19) United States
(12) Patent Application Publication
(10) Pub. No.: US 2016/0054127 A1
(43) Pub. Date: Feb. 25, 2016

(54) Short-path fuzzy navigation method

(71) Applicant: JIFENG GU, Shanghai (CN)

(72) Inventor: JIFENG GU, Shanghai (CN)

(21) Appl. No.: 14/620,206

(22) Filed: Feb. 12, 2015

(30) Foreign Application Priority Data
Aug. 22, 2014 (CN) 201410417948.7

(51) Int. Cl. G01C 21/00

(52) U.S. Cl. CPC G01C 21/00

(57) ABSTRACT

A short-path fuzzy navigation method is provided. The short-path fuzzy navigation method has steps of: a navigation apparatus planning a default path having a plurality of intersections thereon; and the navigation apparatus starting a short-path fuzzy navigation procedure. The short-path fuzzy navigation procedure has steps of: selecting two of the intersections as a starting point and a destination; calculating a plurality of possible paths between the starting point and the destination; for each of the possible paths, determining whether the possible path satisfies predetermined criteria; selecting each possible path which satisfies the predetermined criteria as a candidate path; sending a notice of a driving direction toward each candidate path before reaching the starting point; and terminating the short-path fuzzy navigation procedure when reaching the destination.

### BACKGROUND OF THE INVENTION

1. Field of the Invention

The present invention presents a short-path fuzzy navigation method, and more particularly, a short-path fuzzy navigation method for calculating predetermined criteria.

2. Description of the Prior Art

A navigation apparatus of a car uses global positioning system (GPS) and an electronic map to perform navigation. The navigation apparatus accurately tells the driver the shortest and fastest path to the destination and gives great help to the driver. For the convenience of the driver, majority of available navigation apparatus has several routing modes to choose from:

(a) System recommendation mode: This mode uses a combination of the travelling route, time, cost, etc. for optimization. This mode is a good mode for new users.

(b) Shortest route mode: This mode plans a travelling path to have a shortest distance from the starting point to the destination. This mode is good for saving gas when travelling for a long distance. But when used within the city, it is easy to violate traffic rules such as one way traffic.

(c) Fastest route mode: This mode plans a travelling path that would allow the driver to reach the destination at shortest possible time. This mode selects city main roads and freeways in planning the routes. Thus, result with toll fare expense and many detours.

(d) Freeway avoidance mode: This mode is good for saving money for toll fares.

After selecting one of the routing modes, the navigation apparatus sends a notice for driving direction upon reaching a road junction (i.e. an intersection). If there is a wait such as traffic congestion or traffic light in the road ahead, the driver has no choice but to wait or slowly move with the traffic to follow the path provided by the navigation apparatus. The driver has no way of knowing other alternative routes to avoid traffic congestions or traffic lights.

### SUMMARY OF THE INVENTION

An embodiment of the present invention presents a short-path fuzzy navigation method of a navigation apparatus. The short-path fuzzy navigation method comprises the navigation apparatus planning a default path, the default path having a plurality of intersections; the navigation apparatus starting a short-path fuzzy navigation procedure; and performing navigation by the navigation apparatus according to the default path when the short-path fuzzy navigation procedure is terminated. The short-path fuzzy navigation procedure comprises selecting two different intersections from the intersections of the default path as a starting point and a destination, calculating a plurality of possible paths between the starting point and the destination, determining whether each of the possible paths satisfies predetermined criteria, selecting each of the possible paths satisfying the predetermined criteria as a candidate path, sending a notice of a driving direction to each of the candidate paths before reaching the starting point, and terminating the short-path fuzzy navigation procedure when reaching the destination.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a short-path fuzzy navigation method according to an embodiment of the present invention.

FIG. 2 illustrates a navigation image of the short-path fuzzy navigation method according to an embodiment of the present invention.

### DETAILED DESCRIPTION

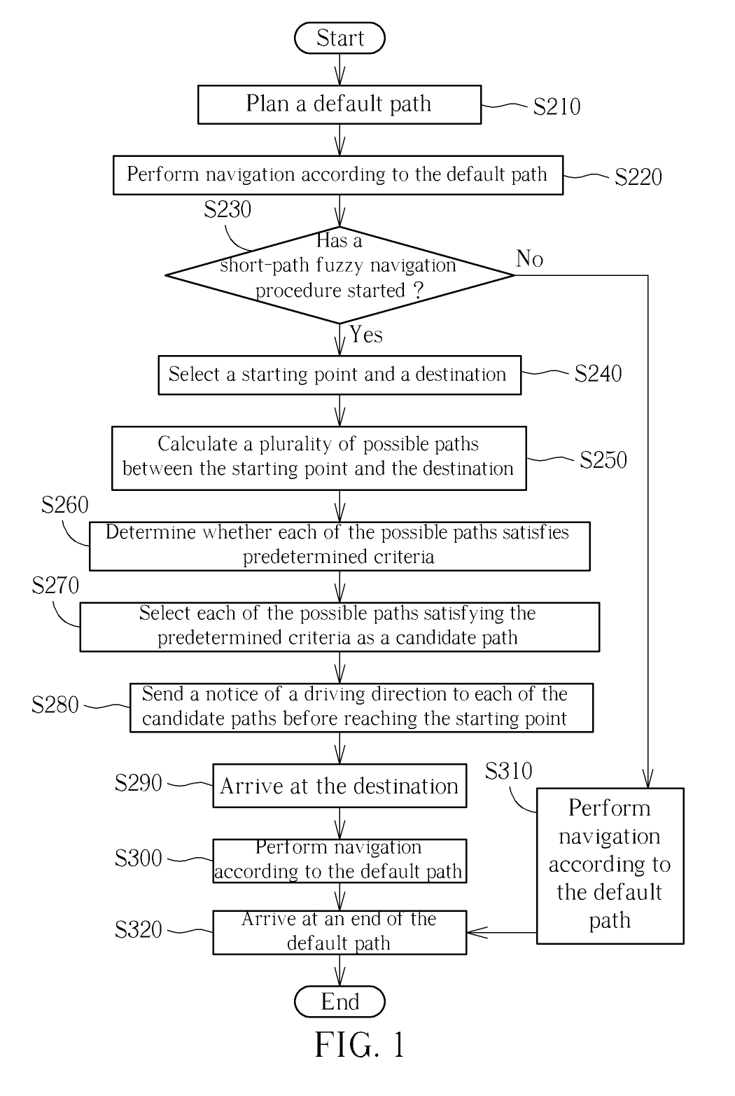

FIG. 1 illustrates a flowchart of a short-path fuzzy navigation method according to an embodiment of the present invention. The short-path fuzzy navigation method may include but is not limited to the following steps:

Step S210: a navigation apparatus plans a default path, the default path having a plurality of intersections;

Step S220: the navigation apparatus performs navigation according to the default path;

Step S230: determine if a short-path fuzzy navigation procedure is started; if yes, go to step S240; else, go to step S310;

Step S240: the navigation apparatus selects two different intersections from the intersections of the default path as a starting point and a destination;

Step S250: the navigation apparatus calculates a plurality of possible paths between the starting point and the destination;

Step S260: the navigation apparatus determines whether each of the possible paths satisfies predetermined criteria;

Step S270: the navigation apparatus selects each of the possible paths satisfying the predetermined criteria as a candidate path;

Step S280: the navigation apparatus sends a notice of a driving direction to each of the candidate paths before reaching the starting point;

Step S290: the navigation apparatus terminates the short-path fuzzy navigation procedure when reaching the destination;

Step S300: the navigation apparatus performs navigation according to the default path;

Step S310: the navigation apparatus continues to perform navigation according to the default path; and

Step S320: arrive at an end of the default path.

Wherein, the short-path fuzzy navigation procedure comprises steps S240 to S290. Furthermore, in the embodiment, if the driving direction to each of the candidate paths comprises going straight, turning right, and turning left, a sequence of sending notices in step 280 may comprise sending a notice to go straight, sending a notice to turn right, and then sending a notice to turn left.

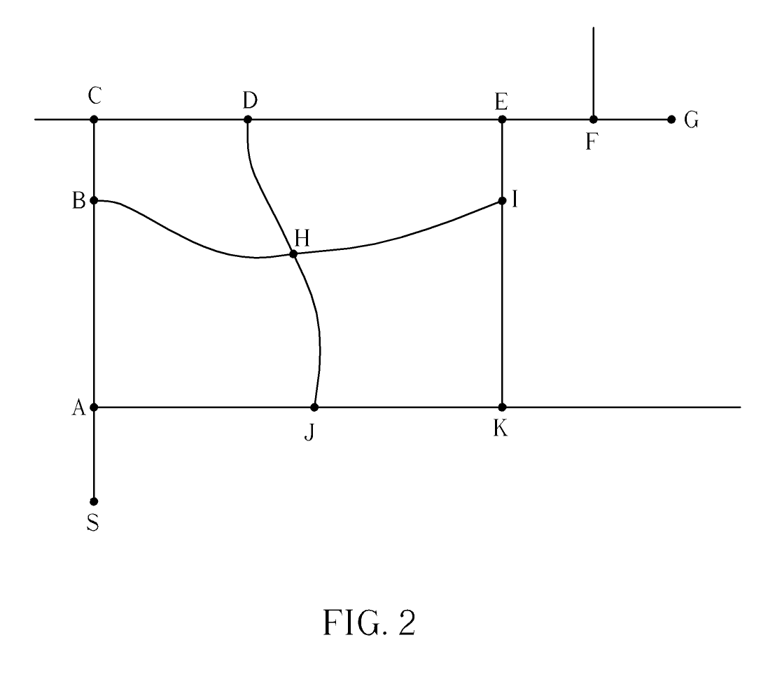

The implementation of the short-path fuzzy navigation method may be described in reference to FIG. 1 and FIG. 2. FIG. 2 illustrates a navigation image of the short-path fuzzy navigation method according to an embodiment of the present invention. In the embodiment, the navigation apparatus may perform navigation from a starting point S to a destination G. The default path planned by the navigation apparatus may include the starting point S→ an intersection A→ an intersection B→ an intersection C→ an intersection D→ an intersection E→ an intersection F→ the destination G. The default path may have a plurality of intersections A, B, C, D, E, and F. After the default path has been planned, the navigation apparatus may perform navigation (Step 220). For example, a user may trigger the navigation apparatus and start the short-path fuzzy navigation procedure when the navigation apparatus is navigated between the starting point S and the intersection A. Because the short-path fuzzy navigation procedure is started, the navigation apparatus may set a second intersection B in front of a current location of the navigation apparatus on the default path as the starting point and the intersection E is set as the destination (Step S240). The intersection E set as the destination is located at the default path between the starting point and the destination G. Furthermore, in another embodiment of the present invention, the navigation apparatus may set a first intersection in front of a current location of the navigation apparatus on the default path (i.e. the intersection A) as the starting point.

After the intersections B and E have been selected as the starting point and the destination, the navigation apparatus may calculate the plurality of possible paths between the starting point B and the destination E (Step S250). The plurality of possible paths may include the following:

(1) First possible path: the intersection B→ the intersection C→ the intersection D→ the intersection E;

(2) Second possible path: the intersection B→ an intersection H→ the intersection D→ the intersection E;

(3) Third possible path: the intersection B→ the intersection H→ an intersection I→ the intersection E; and

(4) Fourth possible path: the intersection B→ the intersection H→ an intersection J→ an intersection K→ the intersection I→ the intersection E;

In step S260, the navigation apparatus may determine whether each of the possible paths satisfies the predetermined criteria. If s is a travelling distance of a possible path of the plurality of possible paths and d is a travelling distance from the starting point to the destination on the default path, then, when a value of (s−d)/d does not exceed a default value, the possible path may be determined to satisfy the predetermined criteria. For example, the travelling distances s of the first possible path, the second possible path, the third possible path, and the fourth possible path may be respectively 10 km, 11 km, 13 km, and 18 km and the default value may be 20%. Because the travelling distance d may be the travelling distance s of the first possible path (10 km), the values of the (s−d)/d corresponding to the first possible path, the second possible path, the third possible path, and the fourth possible path are respectively 0%, 10%, 30%, and 80%. In this case, only the first possible path and the second possible path may be determined to satisfy the predetermined criteria and selected to be the candidate path (Step 270). Afterwards, in Step S280, when the navigation apparatus reaches the intersection B, a notice to go straight towards the intersection C and then a notice to turn right towards the intersection H are sent.

Furthermore, in an embodiment, a possible path may be determined to satisfy the predetermined criteria according to a number of intersections of the possible path. Particularly, M may be a number of intersections of a possible path, and N may a number of intersections passed from the starting point to the destination on the default path. When a value of M−N is less than or equal to a predetermined number, the possible path may be determined to satisfy the predetermined criteria. As shown in FIG. 2, the numbers of intersections M of the first possible path, the second possible path, the third possible path, and the fourth possible path are respectively 4, 4, 4, and 6. Because the number of intersections N may be the number of intersections M of the first possible path (which is 4), the value of the M−N corresponding to the first possible path, the second possible path, the third possible path, and the fourth possible path may respectively be 0, 0, 0, and 2. When the predetermined number 1, only the first possible path, the second possible path, and the third possible path may be determined to satisfy the predetermined criteria and selected to be the candidate path. Afterwards, in step 280, when the navigation apparatus reaches the intersection B, a notice to go straight towards the intersection C and then a notice to turn right towards the intersection H are sent.

In another embodiment, a possible path may be determined to satisfy the predetermined criteria according both the number of intersections of the possible path and the travelling distance. As shown in FIG. 2, when the predetermined number is 1 and the default value is 20%, only the first possible path and the second possible path are determined to satisfy the predetermined criteria and selected to be the candidate path. Afterwards, in step 280, when the navigation apparatus reaches the intersection B, a notice to go straight towards the intersection C and then a notice to turn right towards the intersection H are sent.

According to the short-path fuzzy navigation method of the present invention, the short-path fuzzy navigation procedure may be started such that the user of the navigation apparatus may obtain information of any possible path between the starting point and the destination when the navigation apparatus perform navigation according to the default path. Therefore, more detail traffic information may be obtained, and it is convenient to the user to select an alternative route between the starting point and the destination.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A short-path fuzzy navigation method of a navigation apparatus, comprising:
the navigation apparatus planning a default path, the default path having a plurality of intersections;
the navigation apparatus starting a short-path fuzzy navigation procedure, the short-path fuzzy navigation procedure comprising:
selecting two different intersections from the intersections of the default path as a starting point and a destination;
calculating a plurality of possible paths between the starting point and the destination;
determining whether each of the possible paths satisfies predetermined criteria;
selecting each of the possible paths satisfying the predetermined criteria as a candidate path;
sending a notice of a driving direction to each of the candidate paths before reaching the starting point; and
terminating the short-path fuzzy navigation procedure when reaching the destination; and
performing navigation by the navigation apparatus according to the default path when the short-path fuzzy navigation procedure is terminated.

2. The method of claim 1, further comprising:
performing navigation by the navigation apparatus according to the default path before the navigation apparatus starts the short-path fuzzy navigation procedure.

3. The method of claim 1, wherein the starting point is a first intersection in front of a current location of the navigation apparatus on the default path.

4. The method of claim 1, wherein the starting point is a second intersection in front of a current location of the navigation apparatus on the default path.

5. The method of claim 1, wherein s is a travelling distance of a first possible path of the plurality of possible paths; and d is a travelling distance from the starting point to the destination on the default path; when a value of (s−d)/d does not exceed a default value, the first possible path satisfies the predetermined criteria.

6. The method of claim 1, wherein M is a number of intersections of a first possible path of the plurality of possible paths; and N is a number of intersections passed from the starting point to the destination on the default path; when a value of M−N is less than or equal to a predetermined number, the first possible path satisfies the predetermined criteria.

7. The method of claim 1, wherein s is a travelling distance of a first possible path of the plurality of possible paths; d is a travelling distance from the starting point to the destination on the default path; M is a number of intersections of a first possible path of the plurality of possible paths; and N is a number of intersections passed from the starting point to the destination on the default path; when a value of (s−d)/d does not exceed a default value and a value of M−N is less than or equal to a predetermined number, the first possible path satisfies the predetermined criteria.

8. The method of claim 1, wherein sending the notice of the driving direction to each of the candidate paths comprises sending a notice to go straight, sending a notice to turn right, and sending a notice to turn left, and a sequence of sending notices is sending the notice to go straight, sending the notice to turn right, and then sending the notice to turn left.
